(19) United States
(12) Patent Application Publication
(10) Pub. No.: US 2020/0183350 A1
(43) Pub. Date: Jun. 11, 2020

(54) ELECTRONIC CIRCUIT FOR A FIELD DEVICE USED IN AUTOMATION TECHNOLOGY

(71) Applicant: Endress+Hauser SE+Co. KG, Maulburg (DE)

(72) Inventors: Stefan Rümmele-Werner, Lörrach (DE); Thomas Zieringer, Schopfheim (DE); Lars Karweck, Binzen (DE); Eric Schmitt, Steinsoultz (FR)

(21) Appl. No.: 16/472,546

(22) PCT Filed: Nov. 22, 2017
(86) PCT No.: PCT/EP2017/080066

§ 371 Date: Jun. 21, 2019

(30) Foreign Application Priority Data
Dec. 21, 2016 (DE) 102016125240.9

(51) Int. Cl. G05B 19/042

(52) U.S. Cl. CPC G05B 19/0428; G05B 2219/24024; G05B 2219/25428; G05B 2219/24195; G05B 2219/24188

(57) ABSTRACT

The disclosure is related to an electronic circuit for a field device of automation technology, comprising: a first digital processor having a first set of machine commands for executing an algorithm running in the processor, wherein the first processor is adapted to execute a test algorithm to calculate output data, wherein the test algorithm uses for calculating the output data at least a part of the first set of machine commands, which are used for executing the algorithm, a second digital processor having a second set of machine commands for executing at least one verification algorithm, wherein the second processor is adapted to execute the verification algorithm to calculate verification data, and wherein the electronic circuit including the second processor is adapted, based on the output data calculated by the first processor and the verification data calculated by the second processor, to perform a checking of the first processor.

The invention relates to an electronic circuit for a field device of automation technology and to a method for checking a first digital processor.

In process automation technology as well as in manufacturing automation technology, field devices are often applied, which serve for registering and/or influencing process variables. Serving for registering process variables are measuring devices utilizing sensors, such as, for example, fill-level measuring devices, flow measuring devices, pressure- and temperature measuring devices, pH-redox potential measuring devices, conductivity measuring devices, etc., which register the corresponding process variables, fill level, flow, pressure, temperature, pH value, and conductivity. Serving for influencing process variables are actuators, such as, for example, valves or pumps, via which the flow of a liquid in a pipe, tube or pipeline section, or the fill level in a container, can be changed.

A large number of such field devices are manufactured and sold by the Endress+Hauser group of companies.

Such field devices usually have an electronic sensor circuit. Such sensor circuits are known per se. The electronic sensor circuit is applied in field devices for further processing of raw, measured values. For example, via an analog electrical transducer element, a process variable is registered in the form of raw, measured values, which are digitized via an analog to digital converter, in order then to be able to process the digitized, raw, measured values further via a digital processor with the assistance of an algorithm. In such case, a series of operations can be performed via the digital processor with the raw, measured values. For example, a temperature compensation of the raw, measured values can be performed, in order to obtain a temperature compensated, digital output signal in the form of measured values.

In order to be able to apply such field devices in safety-critical applications, increased requirements for the functioning of the field device are made, so that a failure of the field device does not remain unnoticed. For this, there is, for example, the certification of field devices according to the so-called SIL standard IEC 61508 for functional safety.

For achieving SIL 2, as a rule, diagnostic measures in the form of redundant hardware and/or software are applied for as high as possible failure detection and Safe Failure Fraction (SFF). Thus, for example, a further digital processor is provided, besides the digital processor of the sensor electronics, for further processing the digitized, raw, measured values in the field device. Running in this additional processor is likewise the algorithm, based on which the raw, measured values are further processed. Fed to the additional processor are the same input data as to the processor of the sensor electronics, so that the output data of the additional processor should correspond to the output data of the processor of the sensor electronics. In this way, a simple comparison of the two output data can be performed and, thus, the processor of the sensor electronics monitored.

Disadvantageous in this is that the algorithm has to be written into the additional processor at each start of the field device. This must especially occur when the algorithm in the processor of the sensor electronics changes.

It is, consequently, an object of the invention to provide an opportunity for digital processor monitoring, which is less complicated than the options known from the state of the art.

The object of the invention is achieved by an electronic circuit as defined in independent patent claim 1 and a method for checking a first digital processor as defined in independent patent claim 8.

As regards the electronic circuit, the object is achieved by an electronic circuit for a field device of automation technology, comprising:
a first digital processor, especially a signal processor, having a first set of machine commands adapted for executing an algorithm running in the processor for calculating a measured value based on raw, measured values, wherein the first processor uses at least a part of the first set of machine commands for executing the algorithm, wherein the first processor is, furthermore, adapted to execute a test algorithm, in order to calculate output data based on input data, wherein the test algorithm is divided at least into a start section and an end section and the first processor is adapted to execute at least a part of the algorithm, preferably the total algorithm, between the start section and the end section of the test algorithm, wherein the test algorithm uses for calculating the output data at least a part, preferably all, of the machine commands of the part of the first set of machine commands, which are used for executing the algorithm,
a second digital processor, especially a microprocessor, having a second set of machine commands for executing at least one verification algorithm, wherein the second processor is fed the input data and the output data of the first processor and the second processor is adapted to execute the verification algorithm, in order to calculate verification data based on the fed input data, wherein the verification algorithm uses for calculating the verification data machine commands of the second set corresponding to at least a part, preferably all, of the machine commands of the part of the first set of machine commands, which are used for executing the algorithm, wherein the verification algorithm is permanently coded in the second processor, so that the verification algorithm does not have to be written into the second processor upon starting the field device, and

wherein the electronic circuit, especially the second processor, is adapted, based on the output data calculated by the first processor and the verification data calculated by the second processor, to perform a checking of the first processor.

According to the invention, it is not the algorithm adapted for calculating a measured value based on raw, measured values, which is used in the second processor for checking, but, instead, the test algorithm running in the first processor and the corresponding verification algorithm running in the second processor. Based on the test algorithm, output data are calculated, which are compared with verification data. Via the verification algorithm, all machine commands of the part of the first set of machine commands are checked, which are used for executing the algorithm in the first processor. The verification algorithm serves so-to-say as a “universal algorithm”, which can be used by the manufacturer for all manufactured electronic circuits, independently of whether different algorithms are used in the manufactured circuits. This offers the advantage that the verification algorithm does not have to be transmitted from the first to the second processor, such as is done in the state of the art. Rather, the verification algorithm is permanently coded in the second processor, i.e. stored in a non-volatile memory range associated with the second processor. This can occur, for example, in the manufacturing of the electronic circuit, so that the manufacturer for manufacturing the electronic circuits always places the verification algorithm as a “universal algorithm” in the second processor, e.g. stores such in the associated memory, independently of whether different algorithms are used in the particular manufactured circuits.

By dividing the test algorithm into at least two sections and executing the algorithm between the sections, it can supplementally be assured in the execution in the first processor that the algorithm is completely executed and an otherwise needed sequence counter can be omitted.

An advantageous embodiment of the electronic circuit of the invention provides that the first and/or second processor are/is adapted to execute the test algorithm and/or the verification algorithm cyclically, so that a cyclic checking of the first processor occurs.

Another advantageous embodiment of the electronic circuit of the invention provides that the test algorithm and/or the verification algorithm have/has less executed steps than the algorithm for calculating the measured value.

Another advantageous embodiment of the electronic circuit of the invention provides that the electronic circuit is adapted to produce changing input data, especially input data changing as a function of time, for the test algorithm and to supply such to the first processor for executing the test algorithm and to the second processor for execution of the verification algorithm. Especially, the embodiment can provide that the electronic circuit is further adapted such that the first processor and the second processor use the raw, measured values or values derived therefrom as input data for the test algorithm, and for the verification algorithm, or that the electronic circuit is further adapted such that the first processor and the second processor use a random signal as input data for the test algorithm, and for the verification algorithm, or that the electronic circuit is further adapted such that the first processor and the second processor use a counter signal as input data for the test algorithm, and for the verification algorithm.

As regards the method, the object is achieved by a method for checking, especially cyclically checking, of a first digital processor, especially a digital signal processor, having a first set of machine commands, by a second digital processor having a second set of machine commands, wherein the method comprises steps as follows:
executing, especially cyclically executing, an algorithm for calculating a measured value in the first processor, wherein at least a part of the first set of machine commands of the first processor is used for the executing;
executing, especially cyclically executing, a test algorithm subdivided in the first processor into at least a start section and an end section, wherein at least a part of the algorithm, preferably the entire algorithm, is executed by the first processor between the start section and the end section of the test algorithm, wherein the test algorithm calculates output data based on input data, wherein at least a part, preferably all, of the machine commands of the part of the first set of machine commands, which are used for executing the algorithm, is/are used for calculating the output data;
executing, especially cyclically executing, a verification algorithm in the second processor, especially a microprocessor, wherein verification data are calculated by the verification algorithm based on the input data, wherein for calculating the verification data machine commands of the second set are used, which correspond to at least a part, preferably all, of the machine commands of the part of the first set of machine commands, which are used for executing the algorithm, wherein the verification algorithm is permanently coded in the second processor, so that the verification algorithm does not have to be written into the second processor upon the starting of the field device;

checking, especially cyclically checking, the first processor based on the output data calculated by the first processor and the verification data calculated by the second processor.

An advantageous form of embodiment of the method of the invention provides that used as input data are data changing as a function of time, especially data of a counter or a random signal generator or data of the raw measured value or data derived therefrom.

Another advantageous form of embodiment of the method of the invention provides that the test algorithm is divided into a number of sections, at least, however, into a start section and an end section and the algorithm is executed at least partially, preferably completely, between the start section and the end section.

Another advantageous form of embodiment of the method of the invention provides that in executing the test algorithm and/or the verification algorithm less steps are executed by the first and/or second processor than would be necessary in the case of executing the algorithm for calculating the measured value.

The invention will now be explained in greater detail based on the appended drawing, the figures of which show as follows:

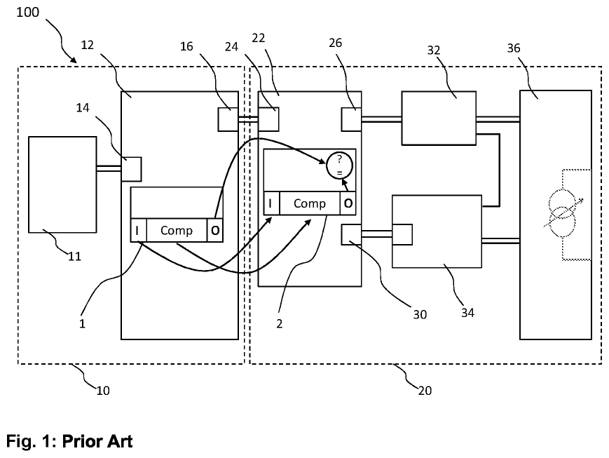

FIG. 1 a schematic block diagram of a field device having an electronic circuit known from the state of the art, and

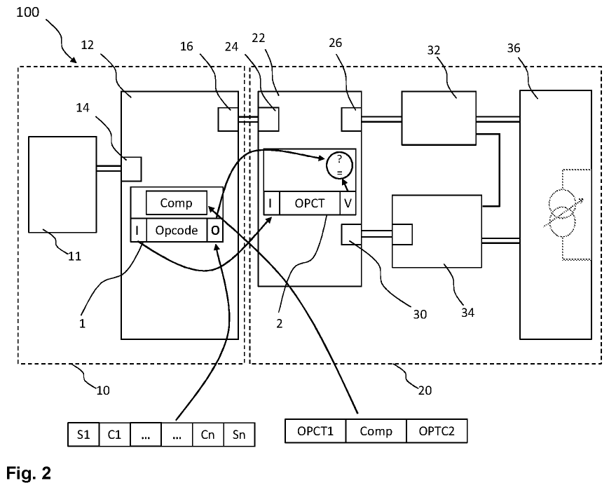

FIG. 2 a schematic block diagram of an example of an embodiment of a field device, which comprises an electronic circuit constructed according to the invention.

The field device 100 shown in FIG. 1 includes an electronic circuit, which is composed of a sensor module 10, a main electronics module 20, and digital communication interfaces 16, 24 complementary to one another.

Sensor module 10 includes a transducer element 11, for example, a capacitively or resistively working, pressure transducer element, and a sensor electronics 12, wherein raw, measured values in the form of a primary signal are led from the transducer element to an analog sensor input 14 of the sensor electronics 12. These raw, measured values are digitized by the sensor electronics 12 and then further processed, or conditioned, by a first digital processor 1, for example, a digital signal processor, by means of an algorithm Comp running on the processor 1, into corresponding measured values. Typically, there occurs by means of the algorithm Comp running in the digital signal processor 1 a temperature compensation of the raw measured value. The conditioned measured value is provided to the main electronics module via a first digital communication interface 16.

The main electronics module 20 includes in the illustrated example of an embodiment a logic unit 22, an electrical current regulator 32, a HART modem 34 and a communication interface, for example, an electrical current sink 36.

Logic unit 22 includes a second digital processor, for example, a microprocessor, and a second digital communication interface 24, which communicates with the first digital communication interface 16. For example, the digital measured value is transmitted via this digital communication connection during normal measurement operation, and the logic unit 22 causes the electrical current regulator 32 via a third digital communication interface 26 so to control the electrical current sink 36 that it carries an analog electrical current signal, which represents the digital measured value or a measured variable derived therefrom.

Furthermore, the logic unit 22 includes a fourth digital communication interface 30, via which the HART modem 34 is operated, in order to modulate onto the analog electrical current signal digital information, for example, status information.

The electronic circuits known from the state of the art are adapted in such a manner that in the first processor 1 the algorithm Comp is executed with at least partial use of the machine commands available for the first processor 1. In order to conform to the above-mentioned SIL measures, the algorithm Comp is employed likewise in the second processor 2. This calculates with the help of the machine commands of the second processor 2 the verification data V on the output. The verification data V obtained by the second processor 2 are then compared with the output data 0 obtained by the first processor 1, in order to enable a checking of the first processor 1.

FIG. 2 shows a schematic block diagram of an example of an embodiment of a field device, which comprises an electronic circuit constructed according to the invention. The field device 100 shown in FIG. 2 and especially its electronic circuit correspond as regards their physical embodiment essentially to the example of an embodiment of FIG. 1.

Different is that the first processor 1 is adapted in such a manner that in it are running both the algorithm Comp as well as also a test algorithm Opcode with the help of at least a part of the machine commands of the first processor 1. The test algorithm Opcode serves to calculate output data 0 based on input data I. The test algorithm Opcode is embodied in such a manner that it uses, at least once, all machine commands, or all Opcodes, which are required for executing the algorithm Comp. Furthermore, the test algorithm Opcode is divided into at least a start section OPCT1 and an end section OPCT2 and the first processor 1 is adapted in such a manner that at least a part of the algorithm Comp, preferably the entire algorithm Comp, is executed between the start section OPCT1 and the end section OPCT2. Another option provides that the test algorithm Opcode and the algorithm Comp are each divided into a plurality of sections C1 . . . Cn, and S1 . . . Sn, and the first processor 1 alternately executes a part of the test algorithm and then a part of the actual algorithm, until the two algorithms have been passed through.

Used as input data I for the test algorithm Opcode can be especially data changing as a function of time. For example, the raw, measured values coming from the transducer element 11 or values derived therefrom can be used. Likewise possible is to use a random signal, for example, a random signal produced by a random signal generator, or a counter signal as input data.

The second processor 2 is adapted in such a manner that a verification algorithm OPCT runs on such with the help of at least a part of the machine commands of the second processor 2. The verification algorithm OPCT serves exactly as the test algorithm Opcode in that, based on the supplied output data 0, which serve as input data, verification data V are calculated. It is embodied in such a manner that it uses at least a part, preferably all, of the machine commands of the second processor 2 corresponding to machine commands, which are required for executing the algorithm Comp in the first processor 1. Essentially, the verification algorithm corresponds, thus, to the test algorithm with the difference that the verification algorithm is adapted for the computer architecture of the second processor and is preferably not divided into sections in the second computer. Typically, however, not necessarily, the test algorithm and/or the verification algorithm have/has less executed steps than the algorithm Comp.

The electronic circuit is, furthermore, adapted to compare the output data calculated by the first processor based on the test algorithm and the verification data calculated by the second processor based on the verification algorithm, and, when a deviation is detected, to output a failure report.

As regards fulfillment of the above described SIL measures, it can be provided that the checking is performed cyclically, i.e. recurringly, in the ongoing measurement operation of the field device 100.

### LIST OF REFERENCE CHARACTERS

100 field device
1 first digital processor
2 second digital processor
10 sensor module
11 transducer element
12 sensor electronics
14 communication interface
16 communication interface
20 main electronics module
22 logic unit
24 communication interface
26 communication interface
30 communication interface
32 electrical current regulator
36 electrical current sink
34 HART modem
Comp algorithm for calculating measured value
Opcode test algorithm
I input data
O output data
OPCT verification algorithm
OPCT1 start section of the verification algorithm
OPCT2 end section of the verification algorithm
V verification data
C1 . . . Cn program sequence, parts of the test algorithm
S1 . . . Sn program sequence, parts of the algorithm

1-11. (canceled)

12. An electronic circuit for a field device of automation technology, comprising:
a first digital processor having a first set of machine commands adapted for executing a measured value algorithm running in the first processor for calculating a digital measured value based on a raw measured value, wherein the first processor uses at least a part of the first set of machine commands for executing the algorithm, wherein the first processor is further adapted to execute a test algorithm to calculate an output data based on an input data, wherein the test algorithm is divided at least into a start section and an end section and the first processor is further adapted to execute at least a part of the measured value algorithm between the start section and the end section of the test algorithm, wherein the test algorithm uses for calculating the output data at least a part of the first set of machine commands which are used for executing the measured value algorithm; and
a second digital processor having a second set of machine commands for executing a verification algorithm, wherein the second processor is fed the input data and the output data of the first processor and the second processor is adapted to execute the verification algorithm to calculate verification data based on the fed input data, wherein the verification algorithm uses for calculating the verification data machine commands of the second set corresponding to at least a part of the first set of machine commands which are used for executing the measured value algorithm, wherein the verification algorithm is permanently coded in the second processor so that the verification algorithm does not have to be written into the second processor upon starting the field device,
wherein the electronic circuit including the second processor is adapted, based on the output data calculated by the first processor and the verification data calculated by the second processor, to perform a checking of the first processor.

13. The electronic circuit as claimed in claim 12, wherein the first processor is adapted to execute the test algorithm cyclically, and the second processor is adapted to execute the verification algorithm cyclically so that a cyclic checking of the first processor occurs.

14. The electronic circuit as claimed in claim 12, wherein the test algorithm and the verification algorithm each have less executed steps than the measured value algorithm for calculating the measured value.

15. The electronic circuit as claimed in claim 12, wherein the electronic circuit is adapted to produce an input data changing as a function of time for the test algorithm and to supply the changing input data to the first processor for executing the test algorithm and to the second processor for executing the verification algorithm.

16. The electronic circuit as claimed in claim 15, wherein the electronic circuit is further adapted such that the first processor and the second processor use the raw, measured values or values derived from the raw, measured values as input data for the test algorithm and for the verification algorithm.

17. The electronic circuit as claimed in claim 15, wherein the electronic circuit is further adapted such that the first processor and the second processor use a random signal as input data for the test algorithm and for the verification algorithm.

18. The electronic circuit as claimed in claim 15, wherein the electronic circuit is further adapted such that the first processor and the second processor use a counter signal as input data for the test algorithm and for the verification algorithm.

19. A method for cyclically checking a first digital processor having a first set of machine commands by a second digital processor having a second set of machine commands, the method comprising:
executing cyclically a measured value algorithm for calculating a measured value in the first processor, wherein at least a part of the first set of machine commands of the first processor is used for the executing;
executing cyclically in the first processor a test algorithm subdivided into at least a start section and an end section, wherein at least a part of the measured value algorithm is executed by the first processor between the start section and the end section of the test algorithm, wherein the test algorithm calculates output data based on input data, wherein at least a part of the first set of machine commands which are used for executing the measured value algorithm is used for calculating the output data;
executing cyclically a verification algorithm in the second processor, wherein verification data are calculated by the verification algorithm based on the input data, wherein for calculating the verification data machine commands of the second set are used, which correspond to at least a part of the first set of machine commands which are used for executing the measured value algorithm, wherein the verification algorithm is permanently coded in the second processor, so that the verification algorithm does not have to be written into the second processor upon the starting the field device; and
checking cyclically the first processor based on the output data calculated by the first processor and the verification data calculated by the second processor.

20. The method as claimed in claim 19, wherein used as input data are data changing as a function of time, including data of a counter or a random signal generator or data of the raw measured value or data derived from the raw measured value.

21. The method as claimed in claim 19, wherein the test algorithm is divided into at least a start section and an end section and the measured value algorithm is executed at least partially between the start section and the end section.

22. The method as claimed in claim 19, wherein in executing the test algorithm and the verification algorithm less steps are executed by the first and second processor than would be necessary in the case of executing the measured value algorithm for calculating the measured value.
